(19) United States
(12) Patent Application Publication
(10) Pub. No.: US 2022/0065414 A1
(43) Pub. Date: Mar. 3, 2022

(54) SOLAR FLASH LIGHT

(71) Applicant: Tung-Yao Yang, Tainan City (TW)

(72) Inventor: Tung-Yao Yang, Tainan City (TW)

(21) Appl. No.: 17/009,733

(22) Filed: Sep. 1, 2020

(51) Int. Cl. F21S 9/03; F21L 4/08; F21V 21/08

(52) U.S. Cl. CPC F21S 9/035; F21L 4/08; F21W 2121/00; F21V 2200/20; F21V 21/0824

(57) ABSTRACT

A solar flash light includes a base, light guiding unit, inserting rod and solar photovoltaic module, where the base is provided with a through inserted hole, and a plurality of light emitting elements in electric connection with a circuit board, each light emitting element is configured in the inserted hole, and the on and off thereof is controlled by the circuit board; the light guiding unit includes two light guiding plates inserted in the inserted hole, and the bottoms of the plates face the corresponding light emitting elements; the surface of each light guiding plate is provided with a decorative pattern, the inserting rod is configured on the bottom of the base, and the solar photovoltaic module is assembled on the inserting rod, thereby converting solar energy into electrical energy to make light emitting elements irradiate, and achieving environmental protection and power saving.

### (a) TECHNICAL FIELD OF THE INVENTION

The present invention relates to a garden light, and more particularly to a light structure powered on for lighting by converting solar energy into electrical power.

### (b) DESCRIPTION OF THE PRIOR ART

Almost every one of the current garden light structures approximately includes a lighting device and a rod configured on the bottom of the lighting device, where a lampshade is provided on the periphery of the lighting device, thereby allowing the light to be softer. However, the above garden lights only have the visual lighting effect, and therefore, their use and appearance are slightly monotonous and boring.

Furthermore, in recent years, with the rise of environmental protection awareness, energy conservation has become the direction of everyone's daily efforts. Among the lighting that wastes much energy, garden landscaping lights consume the most power, because they are for soft vision when illuminated at night, consuming a lot of electricity. Furthermore, more garden lights being installed needs more electrical energy, not conforming to environmental protection, and easily causes electrical fire due to aging power cords.

### SUMMARY OF THE INVENTION

To overcome the above defects, the present invention is proposed.

The main object of the present invention is to provide a solar flash light, including: a base, provided with a through inserted hole; a circuit unit, configured on the base, and including a plurality of light emitting elements in electric connection with a circuit board, each of the light emitting elements irradiating toward the inserted hole, and an on and off sequence of each of the light emitting elements controlled by the circuit board; a light guiding unit, including at least two light guiding plates stacked together on the base, a bottom of each of the light guiding plates provided with at least one light entrance, the light entrances inserted in the inserted hole and facing the corresponding light emitting elements, and a surface of each of the guiding plates provided with a decorative pattern; an inserting rod, one end thereof in connection with a bottom of the base, and another end thereof provided with a tapered inserting portion; and a solar photovoltaic module, including a mounting seat assembled on the inserting rod, a controller and a energy storage element configured inside the mounting seat, and at least one solar panel configured on a top of the mounting seat, the circuit unit, solar panels and energy storage element in electric connection with the controller, with the solar panel receiving solar energy and allowing the solar energy to be converted into electrical energy and outputting the electrical energy to the controller, each of the light emitting elements supplied with the electrical energy through the storage and outputting of the electrical energy of the energy storage element.

Whereby, solar energy is converted into electrical energy to supply the circuit unit with needed power, allowing light of the light emitting elements to enter the corresponding light guiding plates through the corresponding light entrances in sequence, and enabling each of the decorative patterns to form a flashing visual effect, and achieve the purposes of environmental protection and power saving.

### BRIEF DESCRIPTION OF THE DRAWINGS

FIG. 1 is a perspective view of the present invention;

FIG. 2 is an exploded view of the present invention;

FIG. 3 is a perspective view of a preferred embodiment of the present invention;

FIGS. 4 and 5 respectively are an exploded view of the embodiment of the present invention;

FIG. 6 is a plan view of the embodiment of the present invention; and

FIG. 7 is a partly cross-sectional view of the embodiment of the present invention.

### DETAILED DESCRIPTION OF THE PREFERRED EMBODIMENTS

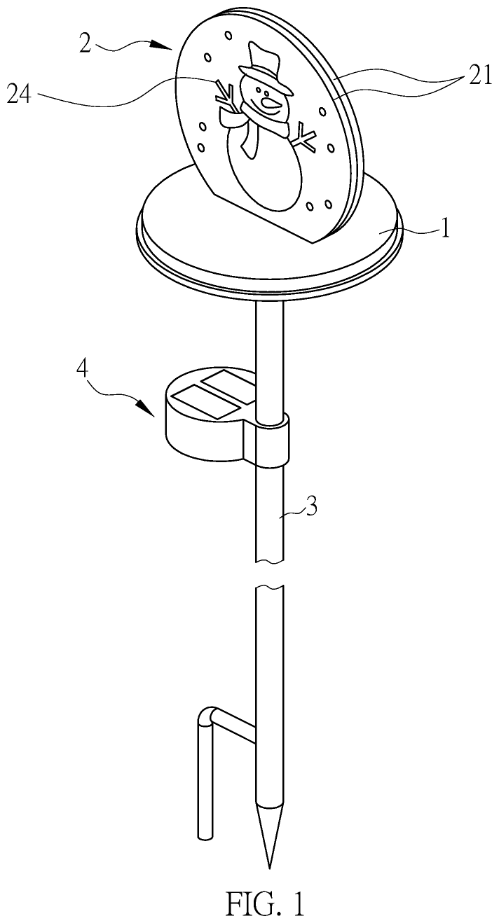

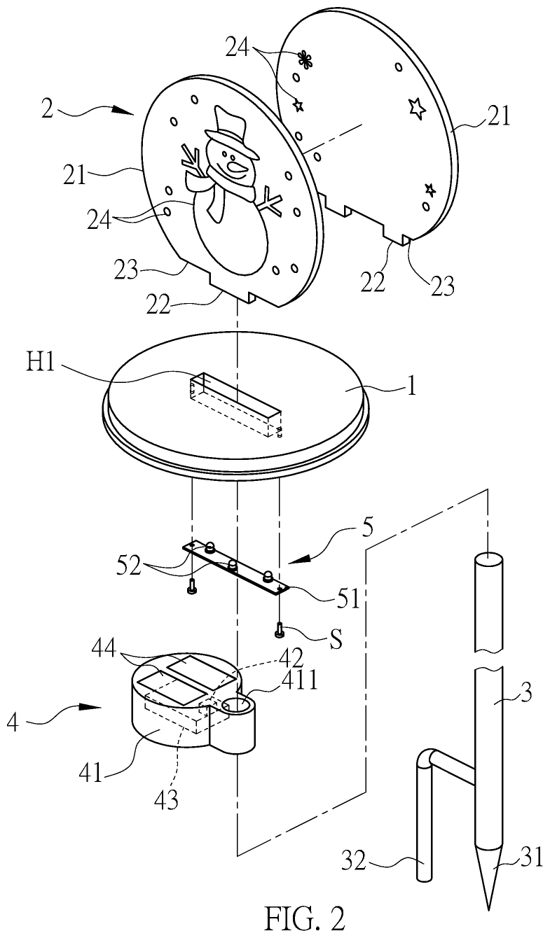

Referring to FIGS. 1 and 2, a solar flash light of the present invention, in a preferred embodiment, includes a base 1, light guiding unit 2, inserting rod 3, and solar photovoltaic module 4.

The base 1 is provided with a through inserted hole H1 and a circuit unit 5, where the circuit unit 5 includes a plurality of light emitting elements 52 respectively in electric connection with a circuit board 51 locked to the bottom of the base 1 with screws S, each of the light emitting elements 52 irradiates the inserted hole H1, and the on-off sequence of each of the light emitting element 52 is controlled by the circuit board 51. In the embodiment, the light emitting element 52 preferably is an LED.

The light guiding unit 2 includes at least two light guiding plates 21 stacked on the top of base 1, the bottom of each of which is provided with at least one light entrance 22, and the light entrances 22 is inserted in the inserted hole H1 and face the corresponding light emitting elements 52; the surface of each of the light guiding plates 21 is configured with a decorative pattern 24, which may be a totem, animal, plant, character or text pattern related to a festival; and the decorative patterns 24 of the two light guiding plates 21 may be a continuous action or staggered arrangement. In addition, the light emitting elements 52 is preferably in contact with the corresponding light entrances 22 of the light guiding plates 21, allowing light to be directly injected into each of the light guiding plates 21. Furthermore, both sides of the light entrance 22 of each of the light guiding plates 21 are respectively provided with a shoulder 23 adapted to lap on the top of the base 1.

One end of the inserting rod 3 is fixed to the bottom of the base 1, and another end thereof is provided with a tapered inserting portion 31 in order to be inserted into the soil, and the present invention does not limit the way of fixation of the inserting rod 3 to the base 1, which may be screwing, adhesion or embedding.

The solar photovoltaic module 4 includes a mounting seat 41, controller 42, energy storage element 43 and at least one solar panel 44, where the controller 42 and energy storage element 43 is configured on the inside of the mounting seat 41, the solar panel 44 the top thereof, and the mounting seat 41 is assembled on the inserting rod 3. In the embodiment, one side of the mounting seat 41 is provided with a sleeve hole 411, with which the mounting seat 41 can be put around the outer periphery of the inserting rod 3, but the present invention is not so limited, screw fixation or clamping may be used for the fixation of the mounting seat 41 to the inserting rod 3; the sleeve hole 411 forms a tight fit with the inserting rod 3, and the mounting seat 41 can be operatively moved up and down along the axis of the inserting rod 3 and rotated about the inserting rod 3, thereby adjusting the angle of sunlight.

As described above, the circuit unit 5, solar panel 44 and energy storage element 43 are in electric connection with the controller 42 adapted to control the electrical energy supply to the circuit unit 5; the energy storage element 42 is a rechargeable battery such as a lithium battery or Ni-MH battery adapted to store and output electrical energy.

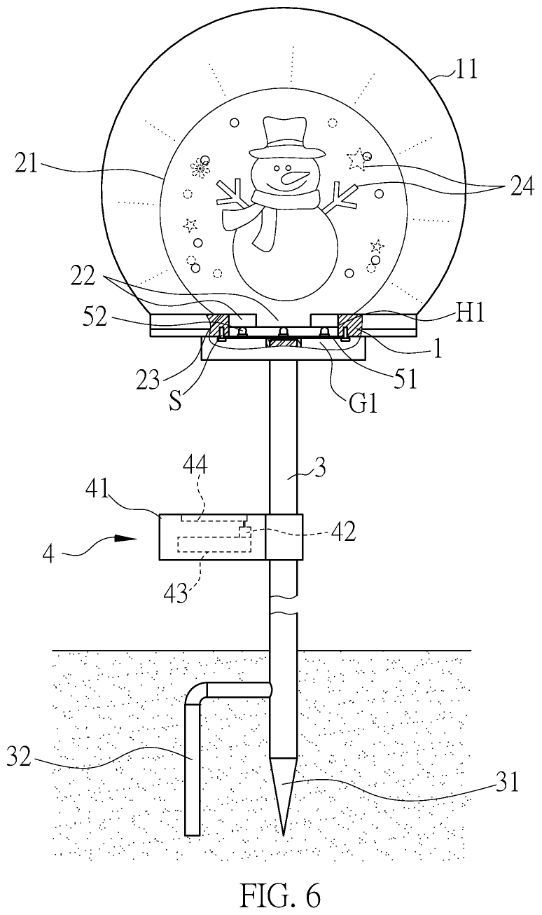

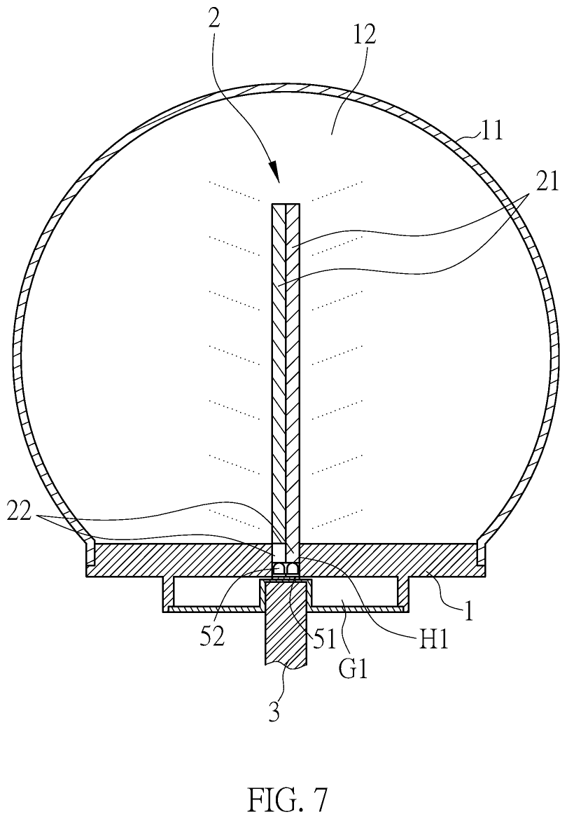

Referring to FIGS. 6 and 7, when the solar panels 44 receive solar energy, they convert the solar energy into electrical energy, and then outputs the electrical energy to the controller 42, the controller 42 will then store the electrical energy in the energy storage element 43. When the present invention is powered on, the electrical energy will be output from the energy storage element 43 to supply the circuit unit 5 with the needed electrical energy. Thereafter, light is generated from the light emitting elements 52, and enters the corresponding light guiding plates 21 through the corresponding light entrances 22, and each decorative pattern 24 is in a flashing state because the sequence and time of the on and off of the light are controlled by the circuit board 51, further allowing the present invention to form an eye-catching visual experience, and at the same time achieve the purpose of environmental protection and power saving.

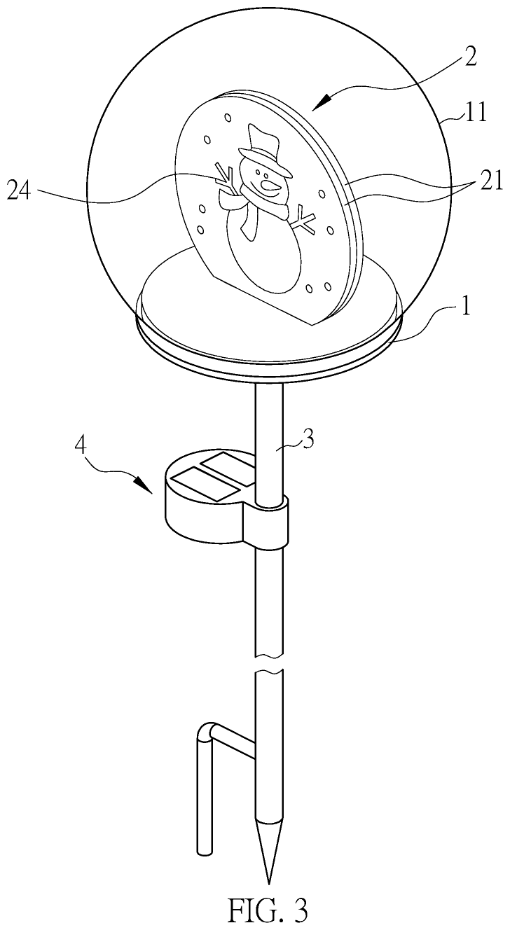

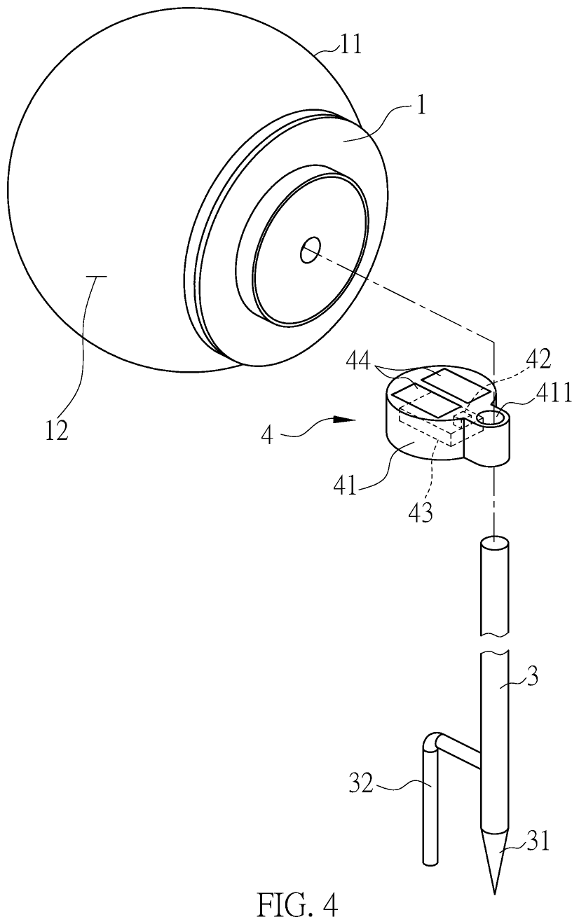

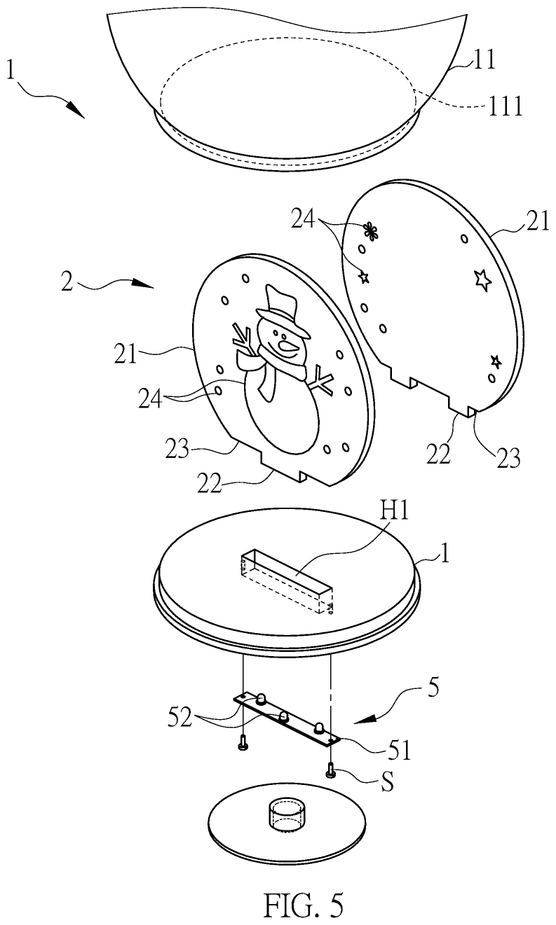

Next, referring to FIGS. 3 to 7, the figures show a variant embodiment of the present invention according to the above structure, such that the structural similarities will not be repeated, and only structural differences are described. In the embodiment, the present invention further includes a hollow shell 11 which may be a transparent three-dimensional body, and it is a sphere for example in the figures, but the present invention is not so limited. The shell 11 has an opening 111 facing downward, and the base 1 is used to close the opening 111 of the shell 11 to enclose an accommodation space 12 with the shell 11, thereby making the light guiding unit 2 positioned inside the accommodation space 12; the base 1 is configured with a through inserted hole H1, and configured downward with a power slot G1 in communication with the inserted hole H1, and the circuit board 51 of the circuit unit 5 is locked to the bottom of the power slot G1; each of the light emitting elements 52 is positioned inside the inserted hole H1 and irradiates toward the accommodation space 12.

In addition, the inserting rod 3 is provided with an orientation cylinder 32 adjacent to the inserting portion 31. In the embodiment, the orientation cylinder 32 is an inverted L-shaped circular cylinder, but the present invention is not so limited; since the inserting rod 3 may still be circumferentially rotated after inserted in the soil, the orientation cylinder 32 have the effect of assisting orientation.

With the configuration of the shell 11, the light guiding unit 2 can be prevented from being directly exposed to the air, which can block dust, dew, and other dirt directly affect the light display effect of the light guide unit 2.

1: A solar flash light, comprising:
a base, provided with a through inserted hole;
a circuit unit, configured on said base, and comprising a plurality of light emitting elements in electric connection with a circuit board, each of said light emitting elements irradiating toward said inserted hole, and an on and off sequence of each of said light emitting elements controlled by said circuit board;
a light guiding unit, comprising at least two light guiding plates stacked together on said base, a bottom of each of said light guiding plates provided with at least one light entrance, said light entrances inserted in said inserted hole and facing said corresponding light emitting elements, and a surface of each of said guiding plates provided with a decorative pattern;
an inserting rod, one end thereof in connection with a bottom of said base, and another end thereof provided with a tapered inserting portion; and
a solar photovoltaic module, comprising a mounting seat assembled on said inserting rod, a controller and an energy storage element configured inside said mounting seat, and at least one solar panel configured on a top of said mounting seat, said circuit unit, solar panels and energy storage element in electric connection with said controller, with said solar panel receiving solar energy and allowing said solar energy to be converted into electrical energy and outputting said electrical energy to said controller, each of said light emitting elements supplied with said electrical energy through the storage and outputting of said electrical energy of said energy storage element, thereby allowing light of said light emitting elements to enter said corresponding light guiding plates through said corresponding light entrances in sequence, and enabling each of said decorative patterns to be in a flash state,
wherein an orientation cylinder is mounted to the inserting rod, the orientation cylinder being of an L-shape having a first limb mounted to and extending from the inserting rod and a second limb extending from a distal end of the first limb and spaced from the inserting rod by a predetermined distance.

2: The light according to claim 1, further comprising a light-transmissible three-dimensional shell having an opening facing downward, said base closing said opening of said shell to enclose an accommodation space with said shell, said light guiding unit positioned inside said accommodation space, and said base is configured downward with a power slot in communication with said inserted hole, and said circuit board fixed to said slot.

3: The light according to claim 1, wherein each of said light guiding plates is respectively configured with a shoulder on two sides of said light entrance, and each of said shoulders is adapted to lap on said base.

4: The light according to claim 1, wherein said energy storage element is a rechargeable battery.

5. (canceled)

6: The light according to claim 1, wherein said mounting seat is provided with a sleeve hole, and said mounting seat is put around an outer periphery of said inserting rod with said sleeve hole.

7: The light according to claim 6, wherein said sleeve hole forms a tight fit with said inserting rod, and said mounting seat is operatively movable along an axis of said inserting rod and rotatable around said axis thereof.

8: The light according to claim 1, wherein said decorative patterns of said two light guiding plates are staggered.

9: The light according to claim 1, wherein said light emitting element is an LED.
